(19) United States
(12) Patent Application Publication
(10) Pub. No.: US 2008/0235202 A1
(43) Pub. Date: Sep. 25, 2008

(54) METHOD AND SYSTEM FOR TRANSLATION OF CROSS-LANGUAGE QUERY REQUEST AND CROSS-LANGUAGE INFORMATION RETRIEVAL

(75) Inventors: Haifeng WANG, Beijing (CN); Jiang Zhu, Beijing (CN)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/036,584

(22) Filed: Feb. 25, 2008

(30) Foreign Application Priority Data
Mar. 19, 2007 (CN) 200710089117.1

(51) Int. Cl. G06F 17/30

(52) U.S. Cl. 707/4; 707/E17.07

(57) ABSTRACT

The present invention provides a method and apparatus for translation of a cross-language query request as well as a cross-language information retrieval method and system. The method for translation of a cross-language query request comprises: translating the cross-language query request from source language into a target language respectively with a plurality of different machine translation systems to obtain a plurality of translations in said target language of the cross-language query request; and constructing a target language query request corresponding to the cross-language query request based on said plurality of translations in said target language of the cross-language query request. The present invention constructs a target language query request by merging translations of cross-language query request generated by a plurality of different machine translation systems and hence improves the retrieval performance of cross-language information retrieval system.

### CROSS-REFERENCE TO RELATED APPLICATION

This application is based upon and claims the benefit of priority from prior Chinese Patent Application No. 200710089117.1, filed on Mar. 19, 2007; the entire contents of which are incorporated herein by reference.

### TECHNICAL FIELD

The present invention relates to information processing technology, in particular, to a method and apparatus for translation of cross-language query request and a method and system for cross-language information retrieval.

### TECHNICAL BACKGROUND

As the popularization of networks, information resources on the networks become richer increasingly and the requirements by users for the network information resources are also increased gradually. However, while the network information resources become increasingly richer, there is a main block preventing these resources from being widely shared by users, i.e. the multilingualism problem. The reason is that the users of current networks mainly obtain network information resources through information retrieval systems, while the conventional information retrieval systems are implemented with respect mainly to a monolingual set of documents. That is, the conventional information retrieval systems generally allow a user to select a certain language as the query language, and return to the user documents meeting the query request, which are in the same language as the query language.

At present, since it is becoming common that users need to retrieve multilingual documents, in order to meet the need by the users for sharing network information resources in different languages, a cross-language information retrieval technology is widely concerned and applied.

The cross-language information retrieval technology is a hotspot technology combining the conventional text information retrieval technology with machine translation (MT) technology. A Cross-Language Information Retrieval (CLIR) system enables a user to submit a query request in a source language selected by the user and search documents in a target language. Specifically, in a cross-language information retrieval system, a MT-system-based query translation method is widely used to implement the cross-language information retrieval. That is, the CLIR system first uses the MT-system-based query translation method to automatically translate a query request of a user from source language to a target language, thus obtaining a translation in the target language for the query request, and then create a query formulation in the target language corresponding to the query request with the translation in the target language, thereby the CLIR system is capable of using the query formulation in the target language to perform a monolingual retrieval for documents in the target language meeting the query request.

However, in previous cross-language information retrieval systems, the translation in a target language for a query request is usually generated directly by a single MT system to formulate the query. So retrieval effectiveness of such a cross-language information retrieval system is influenced greatly by the quality of the translation for the query request generated by the MT system. Thus when the translation quality of the MT system is poor, directly using the translation given by the MT system to formulate query leads to poor retrieval performance.

Therefore, there is a need for a new technology for translation of a cross-language query request and a technology for cross-language information retrieval to improve the retrieval performance of cross-language information retrieval systems.

### SUMMARY OF THE INVENTION

The present invention is proposed in view of the above problem in the prior art, the object of which is to provide a method and apparatus for translation of a cross-language query request and a method and system for cross-language information retrieval, so as to construct queries by merging different translations of a cross-language query request which are generated by different MT systems and hence improve the retrieval performance of cross-language information retrieval system.

According to one aspect of the present invention, there is provided a method for translation of a cross-language query request, comprising: translating the cross-language query request from source language into a target language respectively with a plurality of different machine translation systems to obtain a plurality of translations in said target language of the cross-language query request; and constructing a target language query request corresponding to the cross-language query request based on said plurality of translations in said target language of the cross-language query request.

According to another aspect of the present invention, there is provided a cross-language information retrieval method, comprising: accepting a cross-language query request from a query user; translating the cross-language query request from source language into a target language using the method for translation of a cross-language query request described above to generate a target language query request corresponding to the cross-language query request; and retrieving documents in said target language meeting the target language query request from an information source.

According to another aspect of the present invention, there is provided an apparatus for translation of a cross-language query request, comprising: a plurality of machine translation modules each configured to translate the cross-language query request from source language into a target language, thereby a plurality of translations in said target language of the cross-language query request are obtained; and a target language query request construction module configured to construct a target language query request corresponding to the cross-language query request based on said plurality of translations in said target language of the cross-language query request.

According to another aspect of the present invention, there is provided a cross-language information retrieval system, comprising: an user module configured to accept a cross-language query request from a query user and present retrieval result by the cross-language information retrieval system to the query user; the apparatus for translation of a cross-language query request described above for translating the cross-language query request from source language into a target language to generate a target language query request corresponding to the cross-language query request; and a retrieval module configured to retrieve documents in said target language meeting the target language query request from an information source.

### BRIEF DESCRIPTION OF THE DRAWINGS

FIG. 1 depicts a flowchart of the cross-language information retrieval method according to an embodiment of the present invention;

FIG. 2 depicts a flowchart of the method for translation of a cross-language query request according to an embodiment of the present invention;

FIG. 3 depicts a block diagram of the cross-language information retrieval system according to an embodiment of the present invention; and

FIG. 4 depicts a block diagram of the apparatus for translation of a cross-language query request according to an embodiment of the present invention.

### DETAILED DESCRIPTION OF THE INVENTION

Firstly, an existing cross-language information retrieval system will be introduced briefly prior to the detailed description of the preferred embodiments of the present invention.

The existing cross-language information retrieval system may be an information retrieval system formed on the basis of a conventional information retrieval system by a function for translation of a query request between different languages etc. being added, or may be a newly constructed information retrieval system containing the above function.

That is, an existing cross-language information retrieval system not only relates to the technical field of information retrieval, but also to the technical field of MT. Specifically, by combining the technologies of these two fields, the main procedure that the existing cross-language information retrieval system performs information retrieval is as follows: a user submits a query request to the cross-language information retrieval system so as to form a query formulation in source language; the system identifies the language of the query formulation in source language by using a MT system, performs lexical analysis and structural analysis on it after identifying its source language, and then translates the analyzed query formulation in source language into a query formulation in a certain target language or query formulations each in a certain target language, thus generating corresponding query formulation(s) in target language(s); finally, the generated corresponding query formulation(s) in target language(s) is(are) submitted to the retrieval part of the system so that the information meeting the query request is retrieved from documents in the target language(s) of an information source.

In case that a query request is translated into query formulations each in one of a plurality of target languages, the retrieval result obtained by the cross-language information retrieval system contains information of the plurality of target languages meeting the query request.

In addition, it should be noted that the cross-language information retrieval does not imply such a case that a query request consists of query words in different languages while the information retrieval system does not have such a function to identify the language of the query request and translate it into another language before retrieval, even if the retrieval result obtained by the system contains the information of the various languages. For example, if a query request of [symbol] knowledge” is inputted into an information retrieval system which does not have a function for translation of a query request, and an option for choosing all languages is selected, then during retrieving, all documents will be retrieved out as long as the [symbol] and “knowledge” are both contained therein regardless whether other sections of the documents are in Chinese, English or Japanese. However, since the information retrieval system performs neither identification of language of the query request nor translation between different languages during retrieving, what is carried out by the information retrieval system is not a real cross-language information retrieval during which the documents in target language should be retrieved out by using a source language.

The cross-language information retrieval discussed by the present invention means such a case that a query request in a certain language (source language) is used to retrieve information in other different language(s) (target language(s)).

Next, a detailed description of preferred embodiments of the present invention will be given with reference to the drawings.

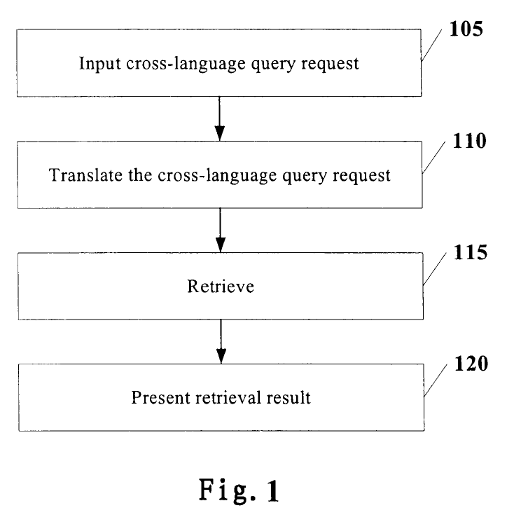

FIG. 1 is a flowchart of the cross-language information retrieval method according to an embodiment of the present invention.

As shown in FIG. 1, first at step 105, a cross-language query request is inputted by query user with a source language and submitted to cross-language information retrieval system. In the embodiment, the source language used by the user for inputting the cross-language query request may be any language that can be supported by the cross-language information retrieval system, such as Chinese, etc. In addition, the cross-language query request inputted by the user may be a single word, a phrase or a term contained in the content interested by the user, or may be an attribute which is closely related to documents and can be used to distinguish documents independently. That is, all the contents related to the documents intent to be retrieved can serve as cross-language query request. It should be noted that the support for a cross-language query request is realized based on database capacity and matching logic of the cross-language information retrieval system and since it is not the character of the present invention, there is no specific limit on the implementation of this step in the invention.

Next, at step 110, the cross-language query request is translated from source language into a target language so as to obtain a target language query request corresponding to the cross-language query request.

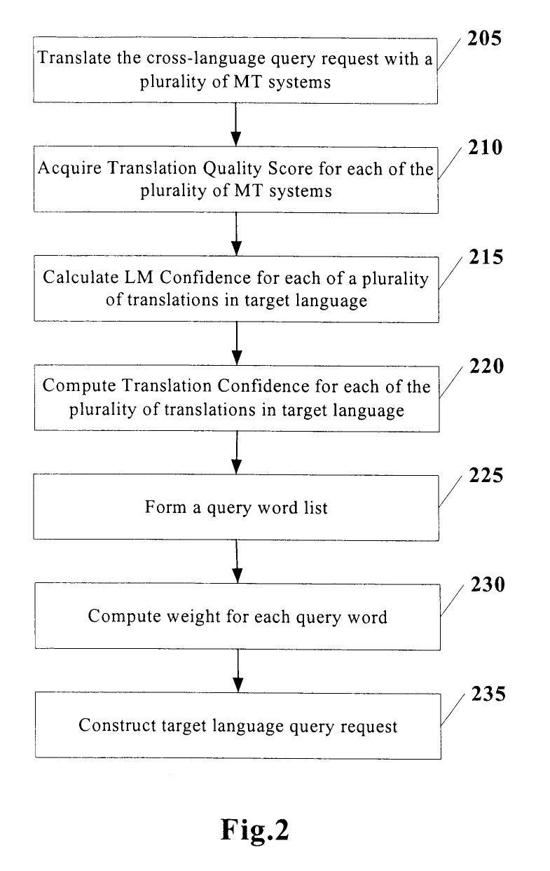

The method for translation of the cross-language query request from the source language to the target language at step 110 in FIG. 1 will be described in detail in conjunction with FIG. 2 hereinafter.

FIG. 2 is a flowchart of the method for translation of the cross-language query request according to an embodiment of the present invention. In this embodiment, for simplicity, only such a case that the above cross-language query request is translated from source language into a target language to retrieve documents meeting the cross-language query request from information in the target language is discussed. In this case, the target language such as English, etc. may be a selected one by the user when submitting the cross-language query request, or may be a defaulted one by the cross-language information retrieval system without the selection by the user.

As shown in FIG. 2, first at step 205, the cross-language query request is translated from source language into a target language with a plurality of different MT systems.

Specifically, at this step, each of the plurality of different MT systems is used to translate the cross-language query request from source language into the specified target language to obtain a translation in the specified target language of the cross-language query request. Thus at this step, a plurality of translations in the target language of the cross-language query request can be obtained by using the plurality of different MT systems.

At this step, for each MT system, its translation procedure for the cross-language query request involves a plurality of nature language processes for the cross-language query request. Specifically, the processing procedure of each MT system mainly comprises source language analysis, translation from source language into a target language, generation of target language and etc., wherein the source language analysis can be further divided into such different analysis levels as lexical analysis, part-of-speech labeling and syntax analysis, semantic analysis, pragmatics and context analysis etc. In addition, the translation between source language and target language is a core technology of MT, which can be implemented specifically on the basis of such translation knowledge as a large bilingual (or multilingual) corpus and labeling thereof. Since the character of the present invention is in how to merge the plurality of translations in target language of the cross-language query request generated by the plurality of different MT systems as described below instead of a specific MT procedure itself, the present invention do not have special limitations on the specific implementations and work procedures of various MT systems, and as long as the translation of a cross-language query request from source language into target language can be carried out, the present invention can be implemented by using any MT system presently known or future knowable.

In addition, it should be noted that, at this step, there is no special limitation on the starting sequence of the plurality of different MT systems. These MT systems can be started sequentially or simultaneously to translate the cross-language query request.

Next, at step 210, for each of the plurality of different MT systems, a Translation Quality Score is acquired. Specifically, in the present embodiment, the Translation Quality Score of each of the plurality of different MT systems is previously generated by offline evaluating the translation quality with respect to the MT system. The evaluation of translation quality can be implemented in a manual evaluation manner that the user selects a test set and establish score levels, and can also be implemented in an automatic evaluation manner that an automatic scoring tool such as Scoring Software of NIST, etc. is used. Further, since the evaluation of translation quality is a common technology in the art and is not the character of the present invention, there is no specific limit on the implementation of this step in the invention.

In addition, it should be noted that, in this embodiment, a Translation Quality Score is generated in advance for each MT system and then is used directly during the translation of a cross-language query request. However, in other embodiments, this step can be implemented in such a way that, first it is determined whether each MT system has a Translation Quality Score evaluated with respect to it, if so the Translation Quality Score will be acquired directly, and if a certain MT system does not have a Translation Quality Score, then an evaluation of translation quality will be performed on the MT system to acquire a Translation Quality Score for it.

At step 215, for each of the plurality of translations in the target language obtained by the plurality of MT systems, a LM Confidence is calculated with a language model. Since it is a common technology in the art to calculate a LM confidence for a translation with a language model, it will not be described in detail further herein.

At step 220, for each of the plurality of translations in the target language of the cross-language query request, the Translation Quality Score of the MT system generating the translation in the target language, which is obtained at step 210, and the LM Confidence of the translation in the target language, which is obtained at step 215, are combined to obtain the Translation Confidence of the translation in the target language. Specifically, in the present embodiment, for each of the plurality of translations in the target language of the cross-language query request, the Translation Quality Score of the MT system generating the translation in the target language, which is obtained at step 210, and the LM Confidence of the translation in the target language, which is obtained at step 215, are multiplied to obtain the Translation Confidence of the translation in the target language. However, in other embodiments, as long as the information representing the translation confidence of a translation in target language can be obtained, other means can also be used to associate the Translation Quality Score of each MT system with the LM Confidence of the translation in target language.

At step 225, the plurality of translations in the target language of the cross-language query request, are combined to form a query word list. Specifically, at this step, query words useful for the retrieval in each of the translations in the target language are identified and function words in each of the translations in the target language are removed, so that the query words useful for the retrieval are combined with each other to form the query word list. Function words refer to words such as prepositions, conjunctions etc. that have little lexical meaning and chiefly indicate a grammatical relationship.

In addition, in this embodiment, when forming the query word list, the identified query words appearing repeatedly in the plurality of translations in the target language are merged, and with respect to the merged query words, information about which translations in the target language they ever appear in are recorded for use in the following step 230. In addition, in other embodiments, these query words appearing repeatedly may also be not merged, and each query word and the information about which translation in the target language it appears in are recorded independently in the query word list.

At step 230, for each query word in the query word list obtained at step 225, a weight is compute. At this step, first the query words and the related information in the query word list as well as the Translation Confidence of each of the plurality of translations in the target language are obtained, then for each query word in the query word list, the Translation Confidences of the plurality of translations in the target language are used to compute a weight based on Translation Confidence.

Specifically, at this step, the TF-IDF algorithm is used to compute the weight for each query word. Hereinafter, by taking a query word list formed based on N translations in the target language of a cross-language query request q as an example, the process of computing a weight for a query word i therein by using the TF-IDF algorithm is illustrated, wherein the Translation Confidence of each translation t (t=1N) in the target language computed at step 220 is used to compute the term frequency of the query word i. That is, what is discussed here is that the cross-language query request q is translated from source language into target language by N MT systems to generate N translations in the target language of the cross-language query request q, and a query word list of the cross-language query request q is formed based on the N translations in the target language. Thus, in this case, for the query word i in the query word list formed based on the N translations in the target language, the weight can be deduced according to the following formulation:

W_{q,i}=TF_{q,i}*IDFᵢ

where

$$I D {F}_{i} = log \frac{D}{{d}_{i}}$$

$${TF}_{q , i} = {\sum }_{i = 1}^{N} {TC}_{t} * {freq}_{t , i}$$

where, W_{q,i} is the weight of query word i in the cross-language query request q;

TF_{q,i} is the weighted term frequency of query word i in the text of the cross-language query request q;

IDFᵢ is the inverse document frequency of query word i;

D is the total number of documents;

dᵢ is the number of documents containing query word i;

freq_{t,i} is the occurrence times of query word i in the translation t in the target language of the cross-language query request q; and

TCₜ is the Translation Confidence of the translation t in the target language of the cross-language query request q.

In addition, it should be noted that, in this embodiment, although the TF-IDF algorithm is used to compute a weight for each of query words in the query word list, this is presented only for the purpose of illustration, but not meant to limit the present invention. Any algorithm, which is able to obtain a weight for each of query words in a query word list based on the Translation Confidence of each of translations in target language, can be used.

Next at step 235, a target language query request corresponding to the cross-language query request is constructed based on the query word list and the weight of each of query words in the query word list. Specifically, at this step, for each query word in the query word list, a <query word: weight> pair is obtained based on the query word and the weight thereof, so that the set of <query word: weight> pairs of all query words in the query word list is jointed to a target language query formulation corresponding to the cross-language query request, which serves as the target language query request for retrieval base.

The above is a description of the method for translation of a cross-language query request according to the present embodiment. It can be seen from the above description, in the present embodiment, a plurality of MT systems are used to translate the cross-language query request input by user from source language into target language to obtain a plurality of translations in the target language for the cross-language query request, and a Translation Confidence is computed for each of the plurality of translations in target language; then all the translations in target language are merged into a query word list containing Translation Confidence information; finally, a target language query formulation corresponding to the cross-language query request is constructed on the basis of the Translation Confidence based weights of the query words in the query word list.

Therefore, in the present embodiment, due to merging the translations in target language of the cross-language query request generated by a plurality of MT systems, a target language query formulation more related to the cross-language query request can be constructed.

In addition, it should be noted that in the description of the method for translation of a cross-language query request according to the present embodiment in conjunction with FIG. 2, the various steps are described in a certain order only for the purpose of simplicity, but not meant to limit the present invention. As long as the object of the present invention can be achieved, these steps can be performed in any order.

In addition, it should be noted that while the present invention is described with respect to the case that the cross-language query request is translated from source language into one specified target language, this is presented only for the purpose of illustration, but not meant to limit the present invention. In a practical implementation, it is also possible that a cross-language query request is translated from source language into a plurality of target languages so that documents meeting the cross-language query request can be retrieved from the information of the plurality of specified target languages. In this case, the plurality of specified target languages may be selected by user when submitting the cross-language query request, or may be defaulted by the cross-language information retrieval system without the selection by the user or all the languages being able to be supported by the system. In addition, in the case that there exists more than one target language, for each of the target languages, the translation process is identical to that in the case of a single target language, thus is not described repeatedly herein.

Returning to FIG. 1, at step 115, based on the target language query request obtained at step 110, matching is performed on the documents for retrieval of an information source to retrieve documents meeting query conditions.

For this step, a description is given by taking the case as an example that the retrieval part in the cross-language information retrieval system is composed of a retrieval module. Specifically, at this step, the target language query request obtained at step 110, i.e., the target language query formulation in the form of <query word: weight> pairs is submitted to the retrieval module; the retrieval module performs matching on the documents for retrieval of the information source based on the target language query formulation to retrieve documents in the target language meeting query conditions as retrieval result for the target language query request. In addition, in this embodiment, there is no special limit on the retrieval module forming the retrieval part in the cross-language information retrieval system, it can be implemented by using any retrieval module (search engine) presently known or future knowable which supports the target language.

In addition, in other embodiments, the retrieval part can also be implemented by using a plurality of different retrieval modules which is able to support one or more certain target languages respectively, which is particularly suitable for the case that the cross-language information retrieval system can support a plurality of target languages simultaneously. In this case, when generating a target language query formulation for a cross-language query request at step 110, target language query formulations in different expression manners should be constructed respectively for the retrieval modules supporting different target languages. In addition, in case that the cross-language information retrieval system uses a plurality of retrieval modules as the retrieval part, the cross-language information retrieval system should further comprises a function for combining the retrieval results of the plurality of retrieval modules. However, since this is not the character of the present invention, there is no specific limit on the implementation thereof.

Next, at step 120, the retrieval result obtained by retrieving based on the target language query request is presented to the user.

The above is a description for the cross-language information retrieval method according to the embodiment. It can be seen from the above description, in the present embodiment, the information of target language meeting query conditions is retrieved based on the target language query request obtained by merging a plurality of translations in target language of the cross-language query request generated by a plurality of machine translation systems, which increasing the precision of the cross-language information retrieval so that the obtained retrieval result is more accurate.

In addition, it should be noted that the cross-language information retrieval method of FIG. 1 and the method for translation of a cross-language query request of FIG. 2 can be used in combination with any cross-language information retrieval system presently known or future knowable.

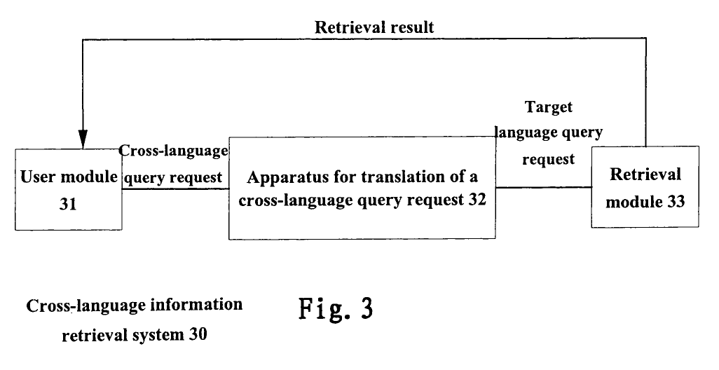

Under the same inventive concept, FIG. 3 is a block diagram of the cross-language information retrieval system according to an embodiment of the present invention.

As shown in FIG. 3, the cross-language information retrieval system 30 according to the present embodiment comprises user module 31, apparatus 32 for translation of a cross-language query request and retrieval module 33.

The user module 31 is configured to accept a cross-language query request in a source language from a query user to submit it to the apparatus 32 for translation of a cross-language query request, and present retrieval result obtained by the retrieval module 33 to the query user. In this embodiment, the source language used by the user to input the cross-language query request may be any which can be supported by the cross-language information retrieval system 30. In addition, in the embodiment, the user module 31 further allows the query user to select one or more target languages when submitting a cross-language query request, in case that the user does not make such selection, the target language(s) defaulted by the cross-language information retrieval system or all the languages that can be supported by the cross-language information retrieval system will be used.

The apparatus 32 for translation of a cross-language query request is used to translate the cross-language query request obtained at the user module 31 from source language into target language, so as to generate a target language query request corresponding to the cross-language query request.

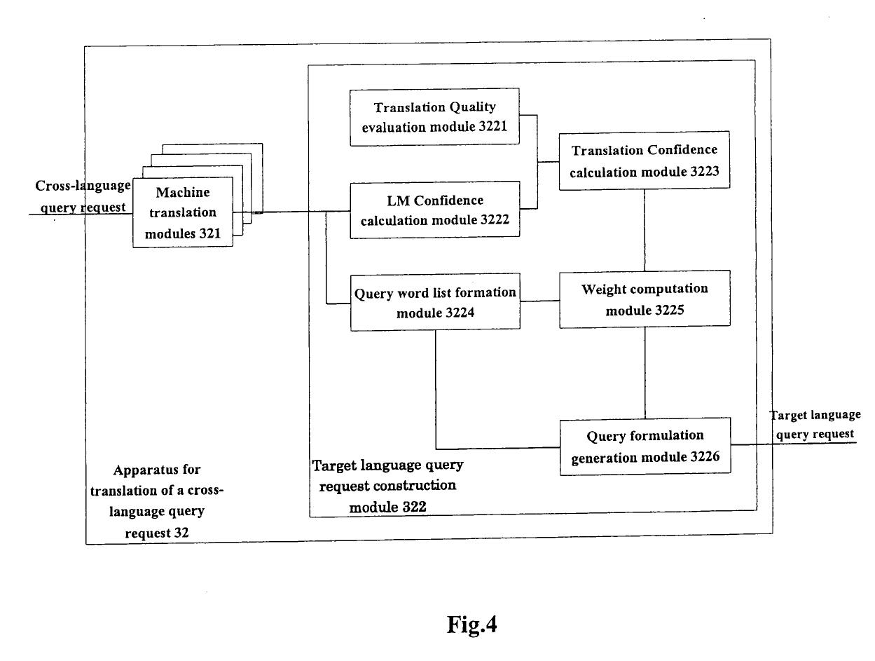

The apparatus 32 for translation of a cross-language query request will be described in detail in conjunction with FIG. 4 below.

FIG. 4 is a block diagram showing the apparatus for translation of a cross-language query request according to an embodiment of the present invention. As shown in FIG. 4, the apparatus 32 for translation of a cross-language query request comprises a plurality of machine translation modules 321 and target language query request construction module 322.

Each of the plurality of machine translation modules 321 is configured to translate the cross-language query request obtained at the user module 31 from source language into a specified target language, thereby a plurality of translations in the target language of the cross-language query request can be obtained. In this embodiment, there is no special limit on the plurality of machine translation modules, as long as the translation of a cross-language query request from source language into target language(s) can be implemented, the present invention can be implemented by using any machine translation system presently known or future knowable.

The target language query request construction module 322 is configured to construct a target language query request corresponding to the cross-language query request based on the plurality of translations in the target language of the cross-language query request obtained by the plurality of machine translation modules 321.

Specifically, as shown in FIG. 4, the target language query request construction module 322 further comprises Translation Quality evaluation module 3221, LM Confidence calculation module 3222, Translation Confidence calculation module 3223, query word list formation module 3224, weight computation module 3225 and query formulation generation module 3226.

The Translation Quality evaluation module 3221 is configured to evaluate translation quality for each of the plurality of machine translation modules 321 to acquire a Translation Quality Score of the machine translation module 321.

The LM Confidence calculation module 3222 is configured to calculate a LM Confidence for each of the translations in the target language of the cross-language query request generated by the plurality of machine translation modules 321 with a language model.

The Translation Confidence calculation module 3223 is configured to calculate a Translation Confidence for each of the translations in the target language generated by the plurality of machine translation modules 321. Specifically, the Translation Confidence calculation module 3223, for each of the plurality of translations in the target language of the cross-language query request obtained by the plurality of machine translation modules 321, multiplies the Translation Quality Score of the machine translation module 321 generating the translation that is evaluated by the Translation Quality evaluation module 3221 by the LM Confidence of the translation in the target language calculated by the LM Confidence calculation module 3222, to obtain the Translation Confidence of the translation in the target language.

The query word list formation module 3224 is configured to merge the plurality of translations in the target language of the cross-language query request obtained by the plurality of machine translation modules 321 to form a query word list. Specifically, in this embodiment, the query word list formation module 3224 identifies query words useful for the retrieval in each of the translations in the target language and removes function words in each of the translations in the target language, so as to combine the query words useful for the retrieval with each other to form the query word list, in which for each of the query words the information about which translations in the target language the query word appears is recorded.

The weight computation module 3225 is configured to compute a weight for each query word in the query word list obtained by the query word list formation module 3224. Specifically, in the embodiment, the weight computation module 3225 uses the Translation Confidence of each of the plurality of translations in the target language calculated by the Translation Confidence calculation module 3223 to compute a weight for each query word in the query word list according to the TF-IDF algorithm described in conjunction with FIG. 2.

The query formulation generation module 3226 is configured to generate <query word: weight> pairs corresponding to the query words based on the query word list formed by the query word list formation module 3224 and the weight of each query word in the query word list computed by the weight computation module 3225, thus constructs a target language query formulation by combining the <query word: weight> pairs of all the query words. And the query formulation generation module 3226 submits the target language query formulation to the retrieval module 33 as a target language query request for retrieval base.

The above is the description of the apparatus for translation of a cross-language query request according to the present embodiment. It can be seen from the description that the apparatus for translation of a cross-language query request according to the present embodiment first uses a plurality of machine translation modules to translate the cross-language query request input by the user from source language into target language to obtain a plurality of translations in target language for the cross-language query request, and computes a Translation Confidence for each of the plurality of translations in target language; then merges all the translations in target language to obtain a query word list containing Translation Confidence information; and finally, constructs a target language query formulation corresponding to the cross-language query request on the basis of the Translation Confidence based weights of the query words in the query word list.

Therefore, due to merging the translations in target language of the cross-language query request generated by a plurality of machine translation modules, the apparatus for translation of a cross-language query request according to the present embodiment can construct a target language query formulation more related to the cross-language query request.

Next, returning to FIG. 3, the retrieval module 33 is configured to, based on the target language query request corresponding to the cross-language query request obtained at the user module 31 generated by the apparatus 32 for translation of a cross-language query request, retrieve documents in the target language meeting the target language query request from information source, as the retrieval result for the cross-language query request, so as to present it to the query user through the user module 31.

The above is the description of the cross-language information retrieval system according to the embodiment. It can be seen from the above description that the cross-language information retrieval system according to the embodiment retrieves information of target language meeting target language query request obtained by merging a plurality of translations in target language of a cross-language query request generated by a plurality of machine translation modules, thus the precision of retrieval is enhanced, and the obtained retrieval result is also more accurate.

In addition, it needs to be noted that the apparatus for translation of a cross-language query request described in conjunction with FIG. 4 can also be combined with any cross-language information retrieval system presently known or future knowable for use.

The cross-language information retrieval system of this embodiment and its components can be implemented with specifically designed circuits or chips or be implemented by a computer (processor) executing corresponding programs. Moreover, the cross-language information retrieval system of the embodiment can operationally implement the cross-language information retrieval method described above in conjunction with FIG. 1.

While the method for translation of a cross-language query request, the cross-language information retrieval method, the apparatus for translation of a cross-language query request and the cross-language information retrieval system of the present invention have been described in detail with some exemplary embodiments, these embodiments are not exhaustive, and those skilled in the art may make various variations and modifications within the spirit and scope of the present invention. Therefore, the present invention is not limited to these embodiments; rather, the scope of the present invention is solely defined by the appended claims.

What is claimed is:

1. A method for translation of a cross-language query request, comprising:
translating the cross-language query request from source language into a target language respectively with a plurality of different machine translation systems to obtain a plurality of translations in said target language of the cross-language query request; and
constructing a target language query request corresponding to the cross-language query request based on said plurality of translations in said target language of the cross-language query request.

2. The method for translation of a cross-language query request according to claim 1, wherein said step of constructing a target language query request further comprises:
merging said plurality of translations in said target language of the cross-language query request to form a query word list;
computing a weight for each query word in the query word list; and
constructing a target language query request corresponding to the cross-language query request based on the query word list and the weight of each query word in the query word list.

3. The method for translation of a cross-language query request according to claim 2, wherein said step of computing a weight for each query word in the query word list further comprises:
calculating a Translation Confidence for each of said plurality of translations in said target language of the cross-language query request; and
using the Translation Confidence of each of said plurality of translations in said target language of the cross-language query request in the computing of the weight for each query word in the query word list.

4. The method for translation of a cross-language query request according to claim 3, wherein said step of calculating a Translation Confidence further comprises:
acquiring a Translation Quality Score of each of the plurality of different machine translation systems;
calculating a LM Confidence for each of said plurality of translations in said target language of the cross-language query request with a language model; and
for each of said plurality of translations in said target language of the cross-language query request, combining the Translation Quality Score of the machine translation system generating the translation in said target language and the LM Confidence of the translation in said target language to obtain the Translation Confidence thereof.

5. The method for translation of a cross-language query request according to claim 4, wherein said step of combining the Translation Quality Score of the machine translation system generating the translation in said target language and the LM Confidence of the translation in said target language further comprises:
multiplying the Translation Quality Score of the machine translation system generating the translation in said target language by the LM Confidence of the translation in said target language.

6. The method for translation of a cross-language query request according to claim 4, wherein the Translation Quality Score of each of the plurality of different machine translation systems is previously generated by evaluating translation quality with respect to the machine translation system.

7. The method for translation of a cross-language query request according to any one of claims 3˜6, wherein said step of using the Translation Confidence of each of said plurality of translations in said target language of the cross-language query request in the computing of the weight for each query word in the query word list further comprises:
using the Translation Confidence of each of said plurality of translations in said target language of the cross-language query request in the computing of the weighted term frequency for each query word in the query word list.

8. The method for translation of a cross-language query request according to any one of claims 3˜6, wherein said step of using the Translation Confidence of each of said plurality of translations in said target language of the cross-language query request in the computing of the weight for each query word in the query word list further comprises:
computing the weight for each query word in the query word list using the Translation Confidence of each of said plurality of translations in said target language of the cross-language query request according to the following algorithm:
W_{q,i}=TF_{q,i}*IDFᵢ
where
$$I D {F}_{i} = log \frac{D}{{d}_{i}} , \\ {TF}_{q , i} = {\sum }_{i = 1}^{N} {TC}_{t} * {freq}_{t , i}$$
wherein, W_{q,i} is the weight of query word i in the cross-language query request q; TF_{q,i} is the weighted term frequency of query word i in the cross-language query request q; IDFᵢ is the inverse document frequency of query word i; D is the total number of documents; dᵢ is the number of documents containing query word i; freq_{t,i} is the occurrence times of query word i in the translation t in said target language of the cross-language query request q; TCₜ is the Translation Confidence of the translation t in said target language of the cross-language query request q.

9. The method for translation of a cross-language query request according to claim 1, wherein the target language query request is the set of query word-weight pairs respectively corresponding to a query word in the cross-language query request.

10. The method for translation of a cross-language query request according to claim 9, wherein the query word-weight pairs are in the form of <query word: weight>.

11. A cross-language information retrieval method, comprising:
accepting a cross-language query request from a query user;
translating the cross-language query request from source language into a target language using the method for translation of a cross-language query request according to any one of the preceding claims 1˜10 to generate a target language query request corresponding to the cross-language query request; and
retrieving documents in said target language meeting the target language query request from an information source.

12. The cross-language information retrieval method according to claim 11, further comprising:
presenting the documents in said target language meeting the target language query request to the query user.

13. An apparatus for translation of a cross-language query request, comprising:
a plurality of machine translation modules each configured to translate the cross-language query request from source language into a target language, thereby a plurality of translations in said target language of the cross-language query request are obtained; and
a target language query request construction module configured to construct a target language query request corresponding to the cross-language query request based on said plurality of translations in said target language of the cross-language query request.

14. The apparatus for translation of a cross-language query request according to claim 13, wherein the target language query request construction module further comprises:
a query word list formation module configured to merge said plurality of translations in said target language of the cross-language query request to form a query word list;
a weight computation module configured to compute a weight for each query word in the query word list; and
a query formulation generation module configured to generate a target language query formulation corresponding to the cross-language query request based on the query word list formed by the query word list formation module and the weight of each query word in the query word list computed by the weight computation module.

15. The apparatus for translation of a cross-language query request according to claims 13 or 14, wherein the target language query request construction module further comprises:
a Translation Confidence calculation module configured to calculate a Translation Confidence for each of the translations in said target language of the cross-language query request generated by said plurality of machine translation modules;
wherein the weight computation module uses the Translation Confidence of each of said plurality of translations in said target language calculated by the Translation Confidence calculation module in the computing of the weight for each query word in the query word list.

16. The apparatus for translation of a cross-language query request according to claim 15, wherein the Translation Confidence calculation module further comprises:
a Translation Quality evaluation module configured to evaluate translation quality for each of said plurality of machine translation modules to acquire a Translation Quality Score of the machine translation module; and
a LM Confidence calculation module configured to calculate a LM Confidence for each of the translations in said target language of the cross-language query request generated by said plurality of machine translation modules with a language model;
wherein the Translation Confidence calculation module, for each of said plurality of translations in said target language of the cross-language query request, multiplies the Translation Quality Score of the machine translation module generating the translation, which is evaluated by the Translation Quality evaluation module, by the LM Confidence of the translation in said target language, which is calculated by the LM Confidence calculation module, to obtain the Translation Confidence of the translation in said target language.

17. The apparatus for translation of a cross-language query request according to claim 15, wherein the weight computation module compute the weight for each query word in the query word list according to the following algorithm:
W_{q,i}=TF_{q,i}*IDFᵢ
where
$$I D {F}_{i} = log \frac{D}{{d}_{i}} , \\ {TF}_{q , i} = {\sum }_{i = 1}^{N} {TC}_{t} * {freq}_{t , i}$$
wherein, W_{q,i} is the weight of query word i in the cross-language query request q; TF_{q,i} is the weighted term frequency of query word i in the cross-language query request q; IDFᵢ is the inverse document frequency of query word i; D is the total number of documents; dᵢ is the number of documents containing query word i; freq_{t,i} is the occurrence times of query word i in the translation t in said target language of the cross-language query request q; TCₜ is the Translation Confidence of the translation tin said target language of the cross-language query request q.

18. A cross-language information retrieval system, comprising:
an user module configured to accept a cross-language query request from a query user and present retrieval result by the cross-language information retrieval system to the query user;
the apparatus for translation of a cross-language query request according to any one of claims 13˜17 for translating the cross-language query request from source language into a target language to generate a target language query request corresponding to the cross-language query request; and
a retrieval module configured to retrieve documents in said target language meeting the target language query request from an information source.
